(19) United States
(12) Patent Application Publication
(10) Pub. No.: US 2007/0168536 A1
(43) Pub. Date: Jul. 19, 2007

(54) Network protocol stack isolation

(75) Inventors: Zorik Machulsky, Gesher HaZiv (IL); Vadim Makhervaks, Austin, TX (US); Julian Satran, Atlit (IL); Leah Shalev, Zichron-Yaakov (IL); IIan Shimony, Haifa (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/333,028

(22) Filed: Jan. 17, 2006

(51) Int. Cl. G06F 15/16

(52) U.S. Cl. 709/230

(57) ABSTRACT

A method and a network architecture for isolation of the network protocol stack from the operating system are provided. The network architecture may include an IO interface arranged to receive and transfer messages from/to the consumer application. The messages may carry high-level generic network device commands, targeted for execution by a particular protocol layer, to which protocol the messages pertain. The network architecture may further included an isolated network protocol stack arranged to process the high-level commands for execution and further arranged to generate device-specific command from the high-level commands, and an IO component arranged to execute the device-specific commands.

### FIELD OF THE INVENTION

The present invention relates generally to the field of computer and processor architecture. In particular, the present invention relates to a method and system for isolation of the network protocol stack from the operating system.

### BACKGROUND OF THE INVENTION

In a traditional networking stack, an application typically requests from the operating system (OS) to transfer data by invoking system calls. The OS typically interacts with an underlying network adapter using a simple packet-based interface. This model imposes high overheads, for example, for context switching, interrupt processing, memory copying and OS internal structure management. For high-speed networks, the overall networking overhead is typically much higher than the time that is left for the application processing by the central processing unit (CPU).

An additional problem is related to the robustness of current computer systems. Typically, each device driver is executed at the OS kernel as a trusted entity. The OS kernel, stack, and the device drivers are all executed in the same protection and resource domain. Therefore, the quality of the drivers affects the reliability of the system, and the systems are rather complex and difficult to test and tune.

Offload adapters, such as iSCSI (Internet Small Computer System Interface) adapters and RDMA (Remote Direct Memory Access) adapters, attempt to address the problems above and to improve the performance of computer systems by moving the processing of the TCP/IP protocol for data path (i.e., not including other IP-related protocols or TCP connection establishment) to the adapter. However, such off load adapters are typically exposed directly to application data transfer interfaces that are different from the simple packet-based interface of the network adapter described above. For example, an RDMA adapter, RNIC, which is a Network Interface Card that provides RDMA services to the consumer, provides an asynchronous interface that allows applications to bypass the OS and to transfer data directly to/from the hardware components, which eliminates some of the overhead mentioned above.

One of the problems with this approach is that such off load adapters typically perform all or most of the transport control protocol (TCP) processing on the adapter, either in custom hardware or in embedded microcode. Therefore, for hardware-based solutions, the protocol implementation is not flexible enough, because, for example, TCP congestion control algorithms are constantly evolving, and, in general, TCP implementation provided with OSs change frequently. Furthermore, for microcode-based solutions the performance is typically limited by the capabilities of the embedded processor, which typically lags behind the host CPUs.

Another problem with this approach is that it further complicates the structure of the IO stack, since new types of device functionalities are introduced. For example, new devices may use different models of splitting the TCP processing between software and hardware, which requires different treatment by the IO stack.

Another attempt at facilitating the problems addressed above is to share a single physical adapter among multiple OS images. This approach is typically necessary in virtualized or partitioned systems, e.g., a physical machine that employs partitioning of the resources, such as memory, to give the appearance and functionality of more than one operating system. It may also be necessary in a cluster of machines, such as a blade server, that typically share the IO node, for example, a cluster of machines connected by a high-speed local area networking system, with Ethernet connectivity provided through a separate node.

Adapter sharing is difficult with state-of-the-art systems for both types of shared adapters described above because it increases hardware and software complexity and/or performance overheads. In order to support multiple OSs, the shared adapter typically has to provide multiple virtual adapter interfaces (i.e. a single physical adapter pretends to be multiple independent adapters), so that each OS can use a separate virtual adapter. With this approach, adapter implementation is complicated, e.g., more registers/queues/etc are needed, the arbitration between the virtual interfaces is complicated, etc.

Another approach is to use an existing adapter and “virtualize” it through a software intermediary component that provides to OSs the illusion of a separate adapter interface. In this case, performance overhead is increased because each operation goes through this intermediary.

### SUMMARY OF THE INVENTION

The present invention may provide a network architecture for use by at least one consumer application and at least one operating system.

The network architecture may include an IO interface arranged to receive and transfer messages from/to the consumer application. The messages may carry high-level generic network device commands targeted for execution by a particular protocol layer, to which protocol the messages pertain. The network architecture may further include an isolated network protocol stack arranged to process the high-level commands for execution and further arranged to generate device-specific commands from the high-level commands, and an IO component arranged to execute the device-specific commands.

Also provided in accordance with another embodiment of the present invention is a computer-implemented method for executing IO requests of a consumer using an isolated network protocol stack.

The method may include posting an IO request to an IO interface, reading the IO request from the IO interface, and initiating an operation based on the IO request. Upon completion of the operation, a response may be posted on the IO interface, and the response may be read.

Also provided in accordance with another embodiment of the present invention, a computer software product, including a computer-readable medium in which computer program instructions are stored, which instructions, when read by a computer, cause the computer to perform the method described above.

### BRIEF DESCRIPTION OF THE DRAWINGS

Embodiments of the present invention will now be described, by way of examples only, with reference to the accompanying drawings in which:

FIG. 1 is a schematic block diagram of a logical view of a network architecture in accordance with an embodiment of the present invention;

FIG. 2 is an exemplary schematic block diagram of a network architecture in accordance with embodiments of the present invention; and

FIG. 3 is an exemplary flow chart diagram of a method for executing IO requests in accordance with an embodiment of the present invention.

### DESCRIPTION OF EMBODIMENTS OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that in order to address the problems mentioned above in the “Background of the Invention” section and to improve the current art, the network protocol stack may be decoupled from the application executing environment, e.g., the operating system (OS), as will be described in detail below. Furthermore, applicants have defined a generic asynchronous request-response protocol, which may be independent of instruction set architecture, of IO attachment type and of device specifics, to allow applications/consumers access to the network protocol stack services. The term “network protocol stack” used throughout this application describes a package implemented in software or hardware that provides general purpose networking services to application software, independent of the particular type of data link being used. This protocol may be used on a wide range of platforms, over a wide range of transports, depending on the actual location of the stack. The network services that may be provided through the protocol above include access to different layers of the network protocol stack, starting from packet-based Media Access Control (MAC) interface, through different types of transport interfaces, e.g., transport control protocol (TCP) or user datagram protocol (UDP), to upper layer protocol interface, e.g., file transfer protocol (FTP), etc.

### LOGICAL DESCRIPTION OF THE SYSTEM

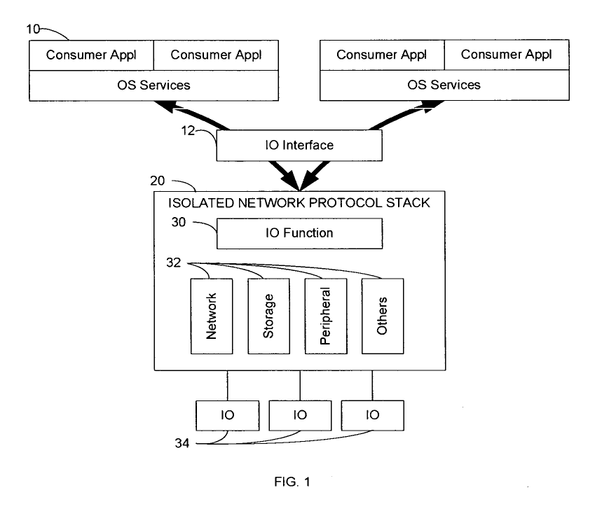

Reference is now made to FIG. 1, which is a schematic block diagram of a logical view of a network architecture in accordance with an embodiment of the present invention.

The network architecture may include consumer applications IO, which may run on a main CPU complex. The consumers may interact with the isolated network protocol stack 20 via OS services using request/response message semantics. The request/response messaging mechanism may be implemented using different interconnects, for example, using message queues in shared memory, e.g., memory which is accessible both by consumer applications 10 and stack 20. The format and content of the request/response messages does not depend on the different interconnects.

The requests, marked by the thick arrows from the consumer applications 10 and the OS services, may pertain to different layers of the network protocol stack 20, through the IO interface 12. For example, the requests may pertain to the MAC layer (e.g., Ethernet), the network layer (e.g., IPv4), the transport layer (e.g., TCP), and/or to the session layer (e.g., iSCSI). IO interface 12 may, for example, determine, to which layer the request is applicable. Accordingly, IO interface 12 may translate incoming requests from consumer applications 10 to requests that may be transferred to stack 20 as will be described below. Also, IO interface 12 may translate incoming requests from different types or versions of OSs that may run on one machine or more. Accordingly, stack 20 may be shared by the multiple heterogeneous consumer applications and OSs.

The requests may be transferred through the IO interface 12 to the isolated network protocol stack 20, and then, via an IO function 30, the respective component 32, e.g., the network, storage, peripheral or other component, may process them. Then, the request may be further transferred to the IO component 34 for execution. It should be noted that the requests that may be passed to the stack may be IO component-independent.

It should be noted that the access to the MAC layer is optional and may require special privileges from the incoming requests.

For each layer, the following are exemplary requests that are supported:

Data transfer requests, which may provide information on data buffer location and length, and indication of data transfer direction. In other words, a consumer application 10 may post either send or receive buffers. The data within the buffers may contain payload of the corresponding stack layer. For MAC layer, it may also include the MAC header. For connectionless protocols, e.g., IP, the send request may specify the address of the recipient, and likewise the remote address information may be supplied with the received data for post receive requests. For connection-oriented protocols, both send and receive requests may specify the connection on which data should be transferred. Additional control information may be specified for each protocol.

Control requests, such as:
get/set supported frame formats at MAC layer;
Open and configure a TCP connection; etc.

Each request may also include information to identify the relevant “logical adapter” component 32, and a request ID which may be transparent to the stack, and it is passed back to the consumer with the corresponding response.

For each request, a response is passed back to the consumer application upon its completion. It may include the required information to identify the original request, e.g., the work request id, and relevant status information, for example, an error code, the actual amount of transferred data, etc.

It should be noted that the isolated network protocol stack may be implemented using different levels of hardware support. The internal implementation may be transparent to the applications or OSs using the services of the isolated network protocol stack. In particular, on a heterogeneous system, e.g., systems with different types of OSs, in order to support a new type of offload device, there is no need for protocol changes in every type of OS.

### SYSTEM DESCRIPTION

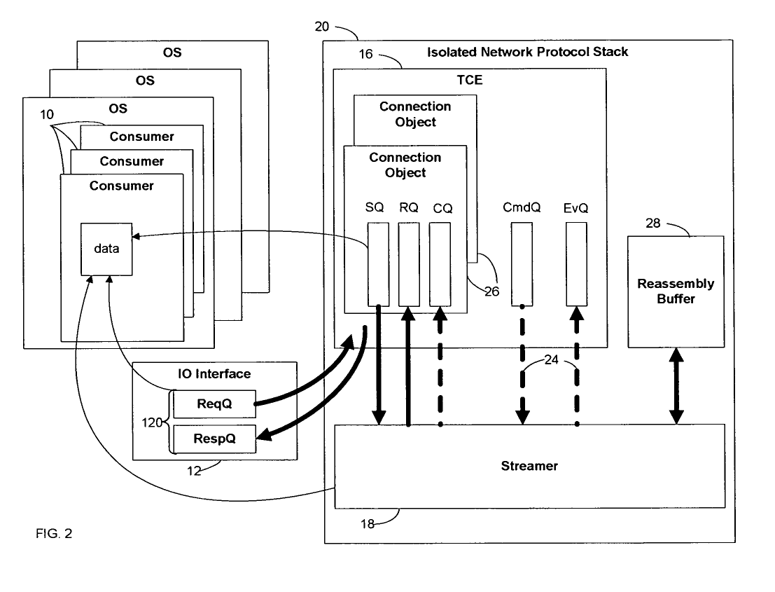

Reference is now made to FIG. 2, which is an exemplary schematic block diagram of a network architecture in accordance with embodiments of the present invention. As shown above, the network architecture may include consumer applications 10, which may run on a main CPU complex. The consumers may interact with the isolated network protocol stack 20 using request/response message semantics. The request/response messaging mechanism may be implemented, for example, using message queues in shared memory, e.g., memory which is accessible by both consumer applications 10 and stack 20. The consumer applications 10 may use asynchronous queue based interface(s) (ReqQ/RespQ) 120, which may be part of the IO interface 12, to submit requests to and from network protocol stack 20, respectively. It should be noted that ReqQ/RespQ interface(s) 120 may be used by a specific consumer application to access multiple stacks, and/or to[?] multiple connections managed by each stack. Further details about an exemplary implementation of the ReqQ/RespQ interface(s) 120 will be described in detail below.

The isolated network protocol stack 20 may include, for example, a transport control engine (TCE) 16, and a streamer 18 component, which may be an example of a hardware support of the isolated network protocol stack mentioned above. The functionality of this exemplary implementation of the isolated network protocol stack will first be briefly described.

TCE 16 may be a software entity which runs on a general-purpose central processing unit (CPU). TCE 16 may control the network protocol stack, and it substantially does not perform data movement. Streamer 18 may be a hardware entity which may accelerate data movement tasks and perform only minimal transport protocol handling. It should be noted that streamer 18 may include an embedded firmware to execute its tasks. The data movement may be configured by TCE 16, on behalf of consumers 10. Streamer 18 may interact with TCE 16 asynchronously, e.g., it is not required to stop its operation to wait for TCE 16 decisions. This functionality allows the stack protocol to scale with the main CPU, e.g., the CPU of the host or the application, since the hardware that assists the functionality does not include any complex processing that can become a bottleneck when the main CPU becomes faster.

Referring now back to the ReqQ/RespQ asynchronous queue based interface(s) 120, an exemplary implementation is described below. In accordance with embodiments of the present invention, the consumer may communicate with the isolated network protocol stack. In the example shown in FIG. 2, there may be a single request queue 120 between a specific consumer and the isolated network protocol stack, which may be used to serve multiple connections to remote hosts, e.g., other computer systems with their own network stacks (of any architecture) and applications using those stacks to communicate with consumer 10. Examples of the formats of the commands that may be passed to the isolated network protocol stack over queue 120 are defined above, e.g., for data transfer requests and control requests. Streamer 18 may cooperate with TCE 16 to provide network acceleration semantics to consumer applications 10. Streamer 18 may be responsible for handling all data intensive operations, as will be described in more detail hereinbelow.

As briefly mentioned above, TCE 16 may be a software component that implements the protocol processing part of the isolated network protocol stack solution. TCE 16 may implement the decision-making part of the TCP protocol. For example, without limitation, TCE 16 may run on a main CPU, dedicated CPU, or on a dedicated virtual host (partition). Streamer 18 and TCE 16 may use an asynchronous dual-queue interface 24 to exchange information between the two parts of solution. The dual-queue interface 24 may include two unidirectional queues. A command queue (CmdQ) may be used to pass information from TCE 16 to streamer 18. An event queue (EvQ) may be used to pass information from streamer 18 to TCE 16. Streamer 18 and TCE 16 may work asynchronously without any need to serialize and/or synchronize operations between them. The architecture does not put restrictions or make assumptions regarding the processing/interface latency between streamer 18 and TCE 16.

As shown above, for applications or consumers 10 that interact with the isolated network protocol stack 20, the protocol processing may be performed on a dedicated and logically separate CPU of TCE 16. TCE 16 may be a physically separate CPU on a symmetric multiprocessor system (SMP) a separate partition on a partitioned machine, or a separate node in a cluster.

In accordance with this embodiment of the present invention, streamer 18 may handle the application requests for data transfer after TCE 16 processes the requests on behalf of the consumers application, e.g., TCE 16 may translate the application requests received via the IO interface 12 (request queue 120) of the isolated network protocol stack from to streamer-specific interface. Additionally, TCE 16 may be involved in processing of requests in case of exceptions, such as segment loss or reordered segments. On the transmit side, TCE 16 may instruct streamer 18 to retransmit data, and on the receive side, 16 TCE may instruct streamer 18 to move data out of reassembly buffer 28 to the application buffers, pointed by entries in the request queue of the IO interface.

In accordance with some embodiments of the present invention, the isolated network protocol stack may be allowed to access the application data buffers, and therefore the data need not be copied when passed to/from the stack. An exemplary method for protecting memory access is described in U.S. Ser. No. [attorney docket IL920050027US1], titled “A METHOD AND SYSTEM FOR MEMORY PROTECTION AND SECURITY USING CREDENTIALS”, which is assigned to the common assignees and filed on even date.

As shown in FIG. 2, the isolated network protocol stack may provide networking services to multiple OS images. This may simplify the structure of the OS, and it may save resources associated with multiplication of network protocol stacks included into each OS instance in accordance with prior-art systems.

According to some embodiments of the present invention, the isolated network protocol stack may provide different levels of adapter sharing. For example, multiple connection-oriented protocol devices such as “virtual TCP devices” may be established when stack 20 is initiated. Therefore, the stack may be viewed as multiple virtual devices at different protocol levels. According to a system-specific policy, exclusive access to a specific device may be granted to some OS images, resulting in a certain virtual TCP device. In other cases, a single physical device is abstracted as multiple logical adapters, and exclusive access to a logical adapter is granted to an OS, as virtual device.

The separation to different connection objects and logical adapters may be done in several ways. For example, in virtual LAN (VLAN) environment, a single physical adapter may be represented as multiple virtual MAC devices, e.g., using VLAN tags. Each MAC device, virtual or physical, may be associated with multiple virtual IP devices bound to that MAC device.

It should be noted that every connection object and virtual device is protected from other objects, for example by using the method and system for protection of IO device as described in U.S. Ser. No. [Attorney docket No. IL920050028US1], titled “A METHOD AND SYSTEM FOR PROTECTION AND SECURITY OF IO DEVICES USING CREDENTIALS”, filed on [date], and assigned to the common assignees of the present invention. Accordingly, the consumer ID and a credential of the device may be used to protect each connection object.

### DATA FLOW

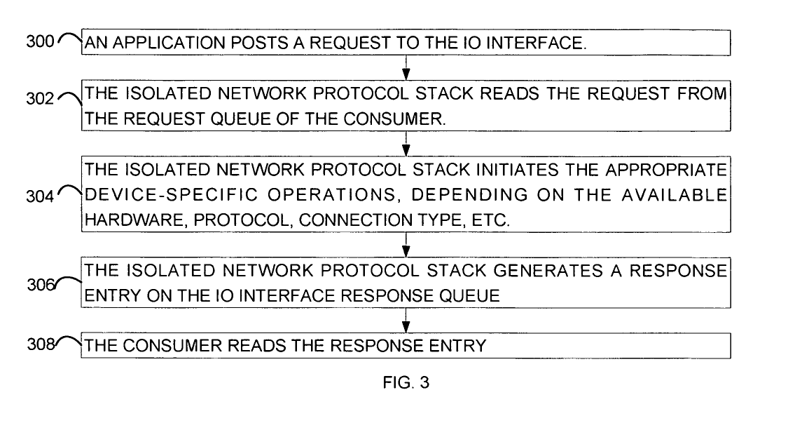

Reference is now made to FIG. 3, which is an exemplary flow chart diagram of a method for executing IO requests in accordance with an embodiment of the present invention. This method is illustrated by showing the data flow from consumer applications to IO devices. This exemplary method may be modified, e.g., multiple operation requests can be passed together.

Initially, an application may post (step 300) an IO request to the IO interface. The request may include information to identify the protocol instance (i.e. virtual network device), the requested operation, and the data buffers if the operation involves data transfer.

The isolated network protocol stack may read (step 302) the request from the request queue of the consumer. It may further interpret the request to decide which operation to perform and on which device, and initiate (step 304) the appropriate device-specific operations, depending on the available hardware, protocol, connection type, etc.

For example, for a TCP send operation, the isolated network protocol stack may read the consumer data and send it to a remote host. Since the TCP data typically cannot be sent immediately, the stack may, for example, first build internal data structures that point to consumer data (to read it right before the transmission), or it may copy the data to intermediate buffers (to be transmitted directly from those buffers when allowed by TCP “rules”).

After the operation is completed, the isolated network protocol stack may generate (step 306) a response entry on the IO interface response queue. The consumer may read (step 308) the response entry. At this point the consumer may use its data buffer again.

In the description above, numerous specific details were set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code that embodies aspects of the present invention is typically maintained in permanent storage, such as a computer readable medium. In a client-server environment, such software programming code may be stored on a client or server. The software programming code may be embodied on any of a variety of known media for use with a data processing system. This includes, but is not limited to, magnetic and optical storage devices such as disk drives, magnetic tape, compact discs (CDs), digital video discs (DVDs), and computer instruction signals embodied in a transmission medium with or without a carrier wave upon which the signals are modulated. For example, the transmission medium may include a communications network, such as the Internet. In addition, while the invention may be embodied in computer software, the functions necessary to implement the invention may alternatively be embodied in part or in whole using hardware components such as application-specific integrated circuits or other hardware, or some combination of hardware components and software. For example, streamer 18 may be embodied in computer software, or alternatively, in part or in whole using hardware components.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

1. A network architecture for use by at least one consumer application and at least one operating system, said network architecture comprising:
an IO interface arranged to receive and transfer messages from/to said consumer application, said messages carrying high-level generic network device commands, targeted for execution by a particular protocol layer, to which protocol said messages pertain;
an isolated network protocol stack arranged to process said high-level commands for execution and further arranged to generate device-specific commands from said high-level commands; and
an IO component arranged to execute said device-specific commands.

2. The network architecture of claim 1, wherein said IO interface is an asynchronous interface arranged to receive and transfer request/response message semantics, and wherein said requests/responses passed between said consumer application and said IO interface are from a first type and the messages passed between said IO interface and said isolated network protocol stack are from a second type.

3. The network architecture of claim 2, wherein said IO interface is used for communication between said at least one consumer application and said at least one operating system and said isolated network stack protocol, wherein, if there are multiple operating systems, said operating systems are from at least one type or version.

4. The network architecture according to claim 3, wherein said IO interface is comprised of multiple requesVresponse interfaces, wherein each request/response interface is used by said consumer application to access one or multiple stacks.

5. The network architecture of claim 1, wherein said request is a data transfer request or a control request.

6. The network architecture of claim 1, wherein said isolated network protocol stack further comprises a transport control engine (TCE) arranged to control said isolated network protocol stack, a streamer arranged to accelerate data movement tasks, and further arranged to process said high-level commands for execution.

7. The network architecture of claim 6, wherein said streamer and said TCE are arranged to communicate via a dual-queue interface to exchange control information.

8. The network architecture of claim 1, wherein said isolated network protocol stack is coupled with said at least one consumer application and said at least one operating system through at least one interconnect.

9. The network architecture of claim 5, wherein said data transfer request or said control request is used by said isolated network protocol stack to provide access to different layers of network protocol stack, wherein said data transfer request or said control request is targeted to a specific virtual device in said isolated network protocol stack, and wherein said data transfer request or said control request instantiates a particular network protocol applicable to said specific virtual device.

10. The network architecture of claim 9, wherein any of said different layers comprises at least any one of the following: a packet-based media access control (MAC) interface, transport control protocol (TCP) or user datagram protocol (UDP) transport interfaces, and file transfer protocol (FTP) upper layer protocol interfaces.

11. A computer-implemented method for executing IO requests of a consumer using an isolated network protocol stack, said method comprising:
posting an IO request to an IO interface;
reading said IO request from said IO interface;
initiating an operation based on said IO request;
transferring data to/from a host computer;
upon completion of said operation in said host, posting a response on said IO interface; and
reading said response.

12. The method of claim 11, wherein said IO request includes information to identify any of the following: a protocol instance, requested operation, and the data buffers if the operation involves data transfer.

13. The method of claim 11, wherein said posting said IO request further comprises posting said IO request on a request queue of said consumer.

14. The method of claim 11, wherein said posting said IO response further comprises generating a response entry on a response queue of said IO interface.

15. The method of claim 11, wherein said IO request is a data transfer request or a control request.

16. A computer software product, including a computer-readable medium in which computer program instructions are stored, which instructions, when read by a computer, cause the computer to perform a method for executing IO requests of a consumer using an isolated network protocol stack, said method comprises:
posting an IO request to an IO interface;
reading said IO request from said IO interface;
initiating an operation based on said IO request;
upon completion of said operation, posting a response on said IO interface; and
reading said response.

17. The method of claim 16, wherein said request includes information to identify any of the following: a protocol instance, requested operation, and the data buffers if the operation involves data transfer.

18. The method of claim 16, wherein said posting said IO request further comprises posting said IO request a request queue of said consumer.

19. The method of claim 16, wherein said posting said IO response further comprises generating a response entry on a response queue of said IO interface.

20. The method of claim 16, wherein said IO request is a data transfer request or a control request.
